(19) United States
(12) Patent Application Publication
(10) Pub. No.: US 2023/0373620 A1
(43) Pub. Date: Nov. 23, 2023

(54) FLAPPING WING AIRCRAFT

(71) Applicant: HANWANG TECHNOLOGY CO., LTD., Beijing (CN)

(72) Inventor: Zhiguo Li, Beijing (CN)

(21) Appl. No.: 18/031,440

(22) PCT Filed: Oct. 9, 2021
(86) PCT No.: PCT/CN2021/122810

§ 371 Date: Apr. 12, 2023

(30) Foreign Application Priority Data
Oct. 12, 2020 (CN) 202022262256.3

(51) Int. Cl. B64C 33/02; B64C 9/06

(52) U.S. Cl. CPC B64C 33/02; B64C 9/06

(57) ABSTRACT

The present disclosure relates to a flapping-wing aircraft, including a tail wing mechanism, which includes a tail rudder stabilizing plane including a first tail rudder stabilizing plane and a second tail rudder, stabilizing plane, wherein an opening is formed between the first tail rudder stabilizing plane and the second tail rudder stabilizing plane, wherein the opening faces a downward direction of the flapping-wing aircraft, and wherein an included angle of the opening is less than 180 degrees.

### TECHNICAL FIELD

The present disclosure relates to a field of aircraft, and in particular, to a flapping-wing aircraft.

### BACKGROUND

In recent years, aircrafts are more and more popular. Existing aircrafts are mainly divided into winged aircrafts and wingless aircrafts. Winged aircrafts include fixed-wing aircrafts such as gliders and moving-wing aircrafts such as rotary wing aircrafts and flapping-wing aircrafts. The tail wing of existing flapping-wing aircraft is generally a planar structure. When a roll occurs to the tail wing of the planar structure during flight due to a disturbance by airflow, the tail wing cannot automatically restore its balanced state, thereby causing the aircraft to be imbalanced.

### SUMMARY

Based on the above, the present disclosure provides a flapping-wing aircraft. The flapping-wing aircraft comprises a tail wing mechanism, which comprises a tail rudder stabilizing plane comprising a first tail rudder stabilizing plane and a second tail rudder stabilizing plane, wherein an opening is formed between the first tail rudder stabilizing plane and the second tail rudder stabilizing plane, and the opening faces the downward direction of the flapping-wing aircraft, and the included angle of the opening is less than 180 degrees.

### BRIEF DESCRIPTION OF DRAWINGS

The above and other objects, features and advantages of the present disclosure will become more apparent by describing the embodiments of the present disclosure in more detail in conjunction with the accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements. In the accompanying drawings,

FIG. 1 shows an example of a flapping-wing aircraft according to an embodiment of the present disclosure;

FIG. 2 shows an example of a tail wing mechanism of the flapping-wing aircraft according to an embodiment of the present disclosure;

FIG. 3 shows a cross-sectional view of the tail wing mechanism of the flapping-wing aircraft according to an embodiment of the present disclosure;

FIG. 4 shows a front projection of a tail rudder stabilizing plane of the tail wing mechanism of the flapping-wing aircraft according to an embodiment of the present disclosure;

FIG. 5 shows a tail rudder blade of the tail wing mechanism of the flapping-wing aircraft according to an embodiment of the present disclosure;

FIG. 6 is an exploded view of a tail rudder component and a steering gear component of the tail wing mechanism of the flapping-wing aircraft according to an embodiment of the present disclosure;

FIG. 7 shows an example of an installation of the tail wing mechanism of the flapping-wing aircraft according to an embodiment of the present disclosure;

FIG. 8 shows a state of the tail rudder blade of the flapping-wing aircraft when it is turning according to an embodiment of the present disclosure; and

FIG. 9 shows a state of the tail rudder blade of the flapping-wing aircraft when it is climbing according to an embodiment of the present disclosure.

### DETAILED DESCRIPTION

The technical solution of the present disclosure will be clearly and completely described below in conjunction with the accompanying drawings. Obviously, the described embodiments are part of the embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that the orientations or positional relationships indicated by terms such as “center”, “upper”, “lower”, “left”, “right”, “vertical”, “horizontal”, “inside” and “outside” are based on the orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, the technical features involved in different embodiments of the present disclosure described below may be combined with each other as long as no conflicts occurs therebetween.

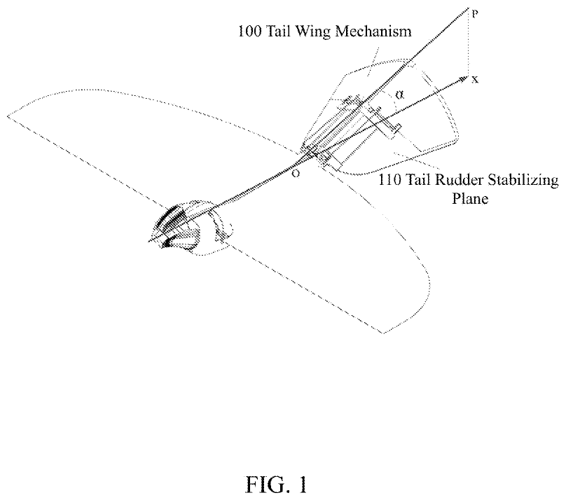

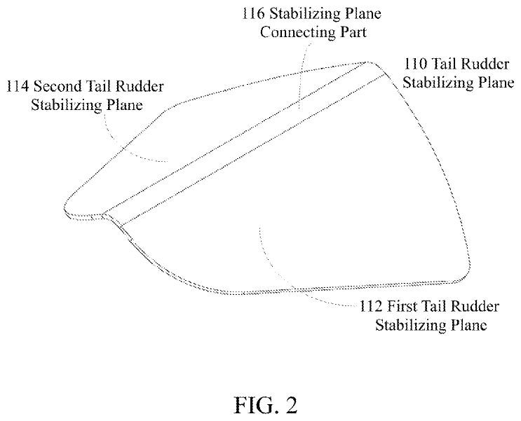

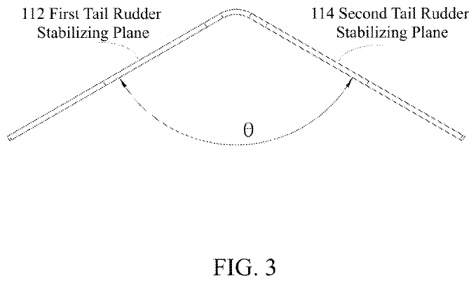

FIG. 1 shows an example of a flapping-wing aircraft according to an embodiment of the present disclosure. As shown in FIG. 1, a flapping-wing aircraft according to the present disclosure may include a tail wing mechanism 100. The tail wing mechanism 100 may include a tail rudder stabilizing plane 110. As shown in FIG. 2, the tail rudder stabilizing plane 110 may include a first tail rudder stabilizing plane 112 and a second tail rudder stabilizing plane 114. The first tail rudder stabilizing plane 112 and the second tail rudder stabilizing plane 114 may be connected by a stabilizing plane connecting part 116. An opening is formed between the first tail rudder stabilizing plane 112 and the second tail rudder stabilizing plane 114. The opening faces the downward direction of the flapping-wing aircraft, and the included angle θ of the opening (i.e., the included angle θ as shown in FIG. 3) is less than 180 degrees. That is, when the flapping-wing aircraft stands upright in front view (e.g., the flapping-wing aircraft is in a state as shown in FIG. 1), as seen from the tail or head of the flapping-wing aircraft, the tail rudder stabilizing plane of the flapping-wing aircraft is inverted V-shaped. In one embodiment, the included angle θ of the opening may be in a range of 90 degrees to 130 degrees, e.g. 120 degrees.

In the present disclosure, the downward direction of the flapping-wing aircraft refers to a direction pointing to the ground when the flapping-wing aircraft stands upright in front view (e.g., the flapping-wing aircraft is in the state depicted in FIG. 1).

It is noted that although there is a stabilizing plane connecting part 116 between the first tail rudder stabilizing plane 112 and the second tail rudder stabilizing plane 114 of the tail rudder stabilizing plane 110 according to the present disclosure as shown in FIG. 2, the tail rudder stabilizing plane 110 as shown in FIG. 2 is merely an example, not a limitation on the present disclosure. For example, in some embodiments, the stabilizing plane connecting part 116 may not be needed, that is, the tail rudder stabilizing plane according to the embodiment of the present disclosure may be inverted V-shaped as a whole.

As shown in FIG. 1, the flapping-wing aircraft whose tail wing mechanism is inverted V-shaped, compared to a flapping-wing aircraft whose tail wing mechanism is a planar structure or upright V-shaped, it can automatically restore its balanced state after being disturbed by rolling, thus improving its balance during flight. Specifically, the existing flapping-wing aircraft might be disturbed by airflow during flight, and the force vertically applied on the tail wing plane by the airflow would cause the flapping-wing aircraft to roll (i.e., the flapping-wing aircraft rolls left and right along the central axis of the fuselage (i.e., the OX axis as shown in FIG. 1)), leading to the imbalance of the flapping-wing aircraft. The inverted V-shaped tail wing mechanism generates a fluid force as it is effected by the airflow, wherein the component of the force perpendicular to the tail wing stabilizing planes on left and right sides can partially or wholly cancel the moment that causes the rolling, so that the flapping-wing aircraft can automatically restore its balanced state when it rolls due to the disturbance by the airflow during flight, which effectively improves the flight stability of the flapping-wing aircraft.

Further, the inventors of the present disclosure have found after a number of experiments that when the included angle of the inverted V-shape is in a range of 90 degrees to 130 degrees, the flapping-wing aircraft has better balance during flight, and when the included angle is 120 degrees, the flapping-wing aircraft has the best balance during flight.

With regard to the installation of the tail wing mechanism, in one embodiment, the tail wing mechanism may be mounted at an elevation angle at the rear end of the flapping-wing aircraft opposite to the orientation of the head of the flapping-wing aircraft, as shown in FIG. 1, wherein the elevation angle is an angle α at which the tail wing mechanism is obliquely mounted upward along the axis of the flapping-wing aircraft parallel to the ground (i.e., the OX axis of the flapping-wing aircraft in the horizontal direction, as shown in FIG. 1). α is in a range of 0 degrees to 90 degrees. The installation in such fashion can generate an uplifting moment in the nose, so that the flapping-wing aircraft can climb upwards at the beginning of the flight, and the upward uplifting posture of the nose accelerates the climbing speed of the flapping-wing aircraft when it is climbing and flying.

With regard to the setting of the elevation angle α, in one embodiment, the magnitude of the elevation angle α may be appropriately set according to design requirements, such as the position of the center of gravity of the flapping-wing aircraft, the magnitude of the uplifting moment expected to be generated in the nose, and the like. For example, in one embodiment, the magnitude of the elevation angle α may be set based on a distance between the center of gravity of the flapping-wing aircraft and the center of gravity of the head of the flapping-wing aircraft. Specifically, the closer the center of gravity of the flapping-wing aircraft is to the front end of the flapping-wing aircraft, the greater the elevation angle is required to be. In one embodiment, the elevation angle α may be in a range of 15 degrees to 25 degrees, e.g. 20 degrees.

In addition, in one embodiment, the first tail rudder stabilizing plane 112 and the second tail rudder stabilizing plane 114 of the tail rudder stabilizing plane 110 according to the present disclosure as shown in FIG. 2 may be symmetrically arranged along the central axis of the tail rudder stabilizing plane (i.e., the OP axis shown in FIG. 1). This arrangement can make the airflow effect on the tail wing mechanism to generate a fluid force whose component perpendicular to the tail wing stabilizing planes on left and right sides can almost wholly cancel the moment that causes the flapping-wing aircraft to roll, which ensures the balance in the rolling of the flapping-wing aircraft during flight and greatly improves the stability of the flapping-wing aircraft during flight.

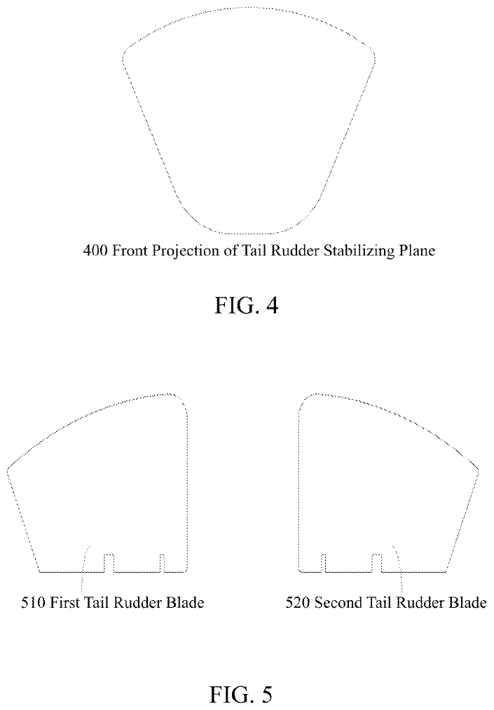

In addition, in one embodiment, the shape of the horizontal front projection of the tail rudder stabilizing plane 110 may be similar to the shape of a tail wing of a bird, e.g., the shape of the front projection 400 of the tail rudder stabilizing plane as shown in FIG. 4. Such a tail rudder stabilizing plane can provide better flight stability.

In addition, in one embodiment, the tail wing mechanism of the flapping-wing aircraft according to the embodiment of the present disclosure may further include a first tail rudder blade (e.g., the first tail rudder blade 510 as shown in FIG. 5) and a second tail rudder blade (e.g., the second tail rudder blade 520 as shown in FIG. 5). In one embodiment, the first tail rudder blade is located on the upper side of the first tail rudder stabilizing plane (such as the first tail rudder stabilizing plane 112 as shown in FIG. 2), and the second tail rudder blade is located on the upper side of the second tail rudder stabilizing plane (such as the second tail rudder stabilizing plane 114 as shown in FIG. 2). In one embodiment, the first tail rudder blade and the second tail rudder blade overlap with a part of the first tail rudder stabilizing plane and a part of the second tail rudder stabilizing plane, respectively, as shown in FIG. 1, for example. By way of example, in one embodiment, the first tail rudder blade and the second tail rudder blade overlap with the rear half of the first tail rudder stabilizing plane and the rear half of the second tail rudder stabilizing plane, respectively. For example, with the rear part from ½ length of the first tail rudder stabilizing plane and the rear part from ½ length of the second tail rudder stabilizing plane. For another example, with the rear part from ⅓ length of the first tail rudder stabilizing plane and the rear part from ⅓ length of the second tail rudder stabilizing plane. It should be noted that the foregoing arrangement with regard to the tail rudder blade and the tail rudder stabilizing plane is merely an example, not a limitation on the present disclosure. Those skilled in the art may design the size of the tail rudder blade appropriately according to design requirements, such as the overall weight, turning efficiency and climbing efficiency of the flapping-wing aircraft. Specifically, the larger the tail rudder blade is, the higher the turning efficiency and climbing efficiency are.

Compared to generally mounting the tail rudder blade at the tail end of the tail wing, the arrangement in which the first tail rudder blade and the second tail rudder blade are located at the upper side of the first tail rudder stabilizing plane and the upper side of the second tail rudder stabilizing plane respectively can ensure the inverted V-shape of the tail wing mechanism as a whole, thereby ensuring the balance of the flapping-wing aircraft during flight. In addition, such installation makes the flapping-wing aircraft more aesthetical as a whole.

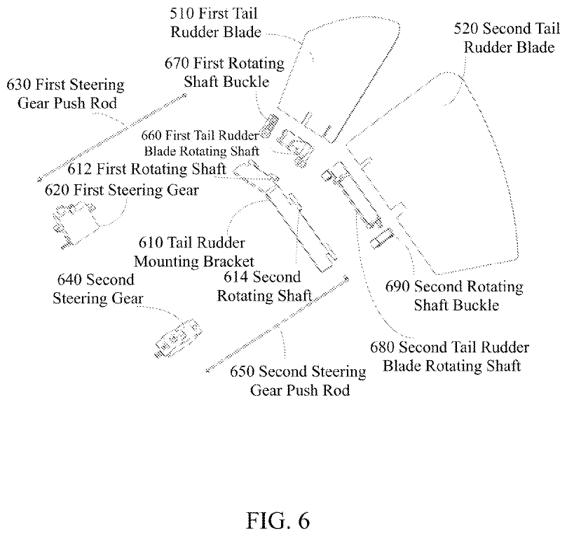

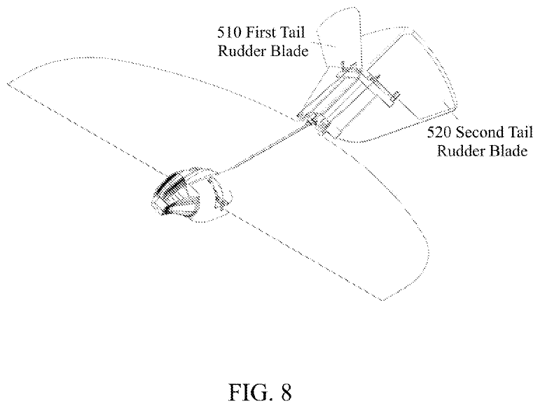

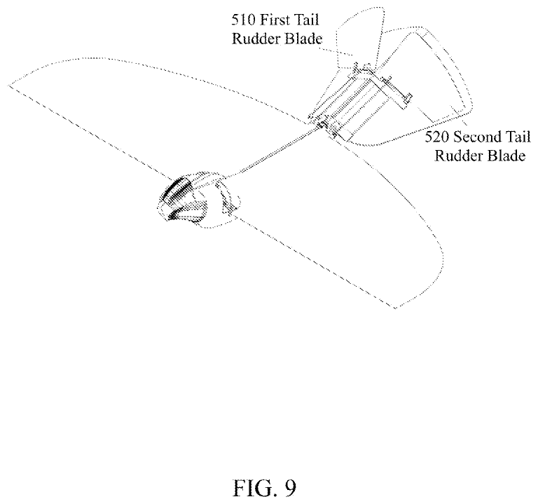

In addition to the tail rudder stabilizing plane and the tail rudder blade as described above, the tail wing mechanism of the flapping-wing aircraft according to the embodiment of the present disclosure may further include components as shown in FIG. 6. As shown in FIG. 6, the tail wing mechanism of the flapping-wing aircraft according to the embodiment of the present disclosure may further include a tail rudder mounting bracket 610, a first steering gear 620, a first steering gear push rod 630, a first tail rudder component consisting of the first tail rudder blade 510, a first tail rudder blade rotating shaft 660 and a first rotating shaft buckle 670, a second steering gear 640, a second steering gear push rod 650, and a second tail rudder component consisting of the second tail rudder blade 520, a second tail rudder blade rotating shaft 680 and a second rotating shaft buckle 690. The first steering gear push rod 630 may connect the first steering gear 620 with the first tail rudder component. The first tail rudder component may be connected (e.g., rotatably connected) with a first rotating shaft 612 on the tail rudder mounting bracket 610 through the first tail rudder blade rotating shaft 660 and the first rotating shaft buckle 670, so that the first tail rudder blade 510 can rotate (e.g., to a position as shown in FIGS. 8 and 9) around the first rotating shaft 612 under the movement of the first steering gear push rod 630. The second steering gear push rod 650 may connect the second steering gear 640 with the second tail rudder component. The second tail rudder component may be connected (e.g., rotatably connected) with a second rotating shaft 614 on the tail rudder mounting bracket 610 through the second tail rudder blade rotating shaft 680 and the second rotating shaft buckle 690, so that the second tail rudder blade 520 can rotate around the second rotating shaft 614 under the movement of the second steering gear push rod 650.

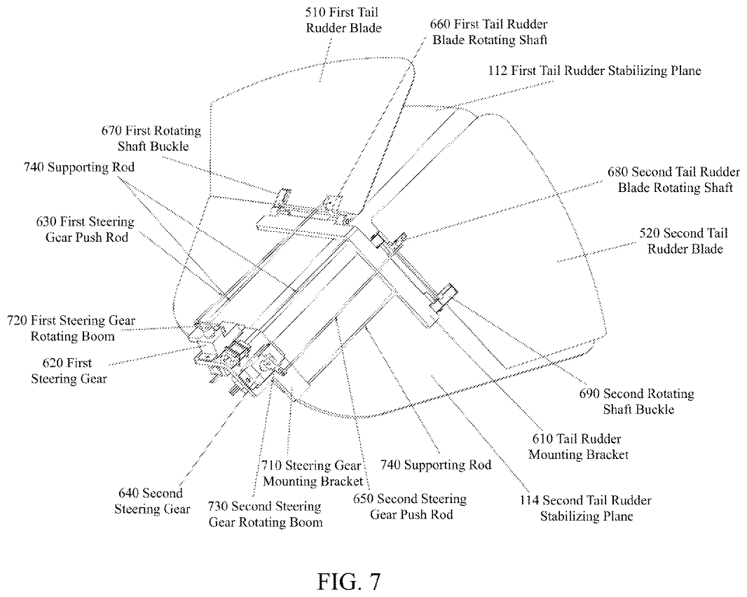

In one embodiment, the first steering gear push rod 630 may be connected with the first steering gear 620 through a first steering gear rotating boom (e.g., the first steering gear rotating boom 720 as shown in FIG. 7). The second steering gear push rod 650 may be connected with the second steering gear 640 through a second steering gear rotating boom (e.g., the second steering gear rotating boom 730 as shown in FIG. 7). When the first steering gear 620 acts, e.g., under the control of the processor, it can drive the first steering gear rotating boom to swing, thereby pulling the first steering gear push rod 630 to move. Similarly, when the second steering gear 640 acts, it can drive the second steering gear rotating boom to swing, thereby pulling the second steering gear push rod 650 to move.

Further, the tail wing mechanism according to the embodiment of the present disclosure may further include a steering gear mounting bracket (e.g., the steering gear mounting bracket 710 as shown in FIG. 7), and a first steering gear (e.g., the first steering gear 620 as shown in FIG. 6) and a second steering gear (e.g., the second steering gear 640 as shown in FIG. 6) may be mounted on the steering gear mounting bracket, and either a supporting rod (e.g., the supporting rod 740 as shown in FIG. 7) may be connected between the steering gear mounting bracket and the tail rudder mounting bracket, or the steering gear mounting bracket 710 and the tail rudder mounting bracket 610 may be integrally arranged to enhance the structural stability and manufacturability of the flapping-wing aircraft. In this embodiment, since the supporting rod is connected between the steering gear mounting bracket and the tail rudder mounting bracket, the tail wing mechanism is more stable.

FIG. 7 shows an example of an installation of a tail wing mechanism including all the components disclosed above according to an embodiment of the present disclosure. It should be understood that FIG. 7 is intended for a better understanding of the present disclosure by those skilled in the art, not a limitation on the present disclosure. Those skilled in the art can add or reduce the components as shown in FIG. 7 as needed and install them appropriately.

In the above, the flapping-wing aircraft according to the present disclosure is described herein with reference to FIGS. 1 to 7. Hereinafter, the state of the tail rudder blade of the flapping-wing aircraft during flight according to the present disclosure will be described herein with reference to FIGS. 8 and 9.

When the flapping-wing aircraft is flying in a straight line, both the first tail rudder blade and the second tail rudder blade may be inactive, that is, they are flush with the tail rudder stabilizing plane, as shown in FIG. 1, for example.

FIG. 8 shows a state of the tail rudder blade of the flapping-wing aircraft when it is turning according to an embodiment of the present disclosure. Specifically, as shown in FIG. 8, the flapping-wing aircraft according to the embodiment of the present disclosure includes a controller, which controls uplifting actions of the first tail rudder blade and the second tail rudder blade. The controller controls one of the first tail rudder blade and the second tail rudder blade (e.g., the first tail rudder blade 510) to be uplifted, so that the flapping-wing aircraft turns towards a direction corresponding to the tail rudder blade. For example, when turning to the right, the controller controls the tail rudder blade on the right side of the flapping-wing aircraft to be uplifted. The elevation by which the tail rudder blade is uplifted would affect the turning radius and turning speed of the steering of the flapping-wing aircraft. Specifically, the elevation by which the tail rudder blade is uplifted is negatively correlated with the turning radius of the steering. That is, the higher the tail rudder on one side is uplifted, the smaller the turning radius for the flapping-wing aircraft is. Whereas, the elevation by which the tail rudder blade is uplifted is positively correlated with the turning speed of the steering. That is, the higher the tail rudder on one side is uplifted, the faster the turning speed is.

FIG. 9 shows a state of the tail rudder blade of the flapping-wing aircraft when it is climbing according to an embodiment of the present disclosure. Specifically, as shown in FIG. 9, when the flapping-wing aircraft according to the embodiment of the present disclosure is climbing (e.g., climbing in a straight line), the controller controls both the first tail rudder blade and the second tail rudder blade to be uplifted, so that the flapping-wing aircraft is in a climbing posture. Similarly, the elevation by which the tail rudder blades are uplifted would affect the climbing angle (i.e., the angle at which the nose is uplifted) and the expected climbing speed. Specifically, the elevation by which the tail rudder blades are uplifted is positively correlated with the climbing angle and the climbing speed. That is, the greater the elevation by which both the first tail rudder blade and the second tail rudder blade are uplifted is, the greater the angle at which the nose is uplifted is and the faster the flapping-wing aircraft climbs.

So far, the present disclosure has described the flapping-wing aircraft according to the embodiment of the present disclosure in conjunction with the accompanying drawings. Compared to the flapping-wing aircraft whose tail wing mechanism is a planar structure or upright V-shaped, the flapping-wing aircraft according to the embodiment of the present disclosure can automatically restore its balanced state after being disturbed by rolling, due to the inverted V-shape of its tail wing mechanism. In addition, the shape of the horizontal front projection of the tail rudder stabilizing plane of the tail wing mechanism of the flapping-wing aircraft according to the embodiment of the present disclosure is similar to the shape of a tail wing of a bird, which may provide better flight stability. Moreover, the tail wing mechanism of the flapping-wing aircraft according to the embodiment of the present disclosure includes a first tail rudder blade and a second tail rudder blade which are located on the upper side of the first tail rudder stabilizing plane and the upper side of the second tail rudder stabilizing plane, respectively. This arrangement can ensure the inverted V-shape of the tail wing mechanism as a whole, thereby improving the balance of the flapping-wing aircraft during flight.

It should be noted that the above description is only some embodiments of the present disclosure and an illustration of the applied technical principles. It should be understood by those skilled in the art that the disclosure scope involved in the present disclosure is not limited to the technical solutions resulted from specific combinations of the above technical features, but also encompasses other technical solutions resulted from any combination of the above technical features or their equivalents without departing from the above disclosed concept, for example, the technical solutions formed by replacing between the above features and the technical features with similar functions disclosed in the present disclosure (but not limited thereto).

In addition, although the operations are depicted in a specific order, this should not be understood as requiring these operations to be performed in the specific order shown or in a sequential order. In certain circumstances, multitasking and parallel processing may be beneficial. Likewise, although several specific implementation details are included in the above discussion, these should not be interpreted as limiting the scope of the present disclosure. Some features described in the context of separate embodiments can also be implemented in a single embodiment in combination. On the contrary, various features described in the context of a single embodiment can also be implemented in multiple embodiments alone or in any suitable sub-combination.

Although the subject matter has been described in a language specific to structural features and/or logical acts of methods, it should be understood that the subject matter defined in the appended claims is not necessarily limited to the specific features or acts described above. On the contrary, the specific features and actions described above are merely example forms of implementing the claims.

The present application claims the priority of Chinese patent application No. 202022262256.3 filed on Oct. 12, 2020, and the contents disclosed in the above Chinese patent application are cited in its entirety as a part of the present application.

1. A flapping-wing aircraft, comprising a tail wing mechanism, which comprises a tail rudder stabilizing plane comprising a first tail rudder stabilizing plane and a second tail rudder stabilizing plane, wherein an opening is formed between the first tail rudder stabilizing plane and the second tail rudder stabilizing plane, wherein the opening faces a downward direction of the flapping-wing aircraft, and wherein an included angle of the opening is less than 180 degrees.

2. The flapping-wing aircraft according to claim 1, wherein the first tail rudder stabilizing plane and the second tail rudder stabilizing plane are symmetrically arranged along a central axis of the tail rudder stabilizing plane.

3. The flapping-wing aircraft according to claim 1, wherein the included angle of the opening is in a range of 90 degrees to 130 degrees.

4. The flapping-wing aircraft according to claim 3, wherein the included angle of the opening is 120 degrees.

5. The flapping-wing aircraft according to claim 1, wherein the tail wing mechanism further comprises a first tail rudder blade and a second tail rudder blade, and wherein the first tail rudder blade is located on an upper side of the first tail rudder stabilizing plane, and the second tail rudder blade is located on an upper side of the second tail rudder stabilizing plane.

6. The flapping-wing aircraft according to claim 1, wherein the tail wing mechanism is mounted at an elevation angle at a rear end of the flapping-wing aircraft opposite to an orientation of a head of the flapping-wing aircraft, and wherein the elevation angle is an angle at which the tail wing mechanism is obliquely mounted upward along an axis of the flapping-wing aircraft parallel to the ground.

7. The flapping-wing aircraft according to claim 6, wherein the closer the center of gravity of the flapping-wing aircraft is to the front end of the flapping-wing aircraft, the greater the elevation angle is.

8. The flapping-wing aircraft according to claim 7, wherein the elevation angle is in a range of 15 degrees to 25 degrees.

9. The flapping-wing aircraft according to claim 1, wherein the front projection of the tail rudder stabilizing plane on the horizontal plane of the flapping-wing aircraft is in a shape of a tail wing of a bird.

10. The flapping-wing aircraft according to claim 1, wherein the tail wing mechanism further comprises a tail rudder mounting bracket, a first steering gear, a first steering gear push rod, a first tail rudder component consisting of a first tail rudder blade, a first tail rudder blade rotating shaft and a first rotating shaft buckle, a second steering gear, a second steering gear push rod, and a second tail rudder component consisting of a second tail rudder blade, a second tail rudder blade rotating shaft and a second rotating shaft buckle; wherein the first steering gear push rod connects the first steering gear with the first tail rudder component, wherein the first tail rudder component is rotatably connected with a first rotating shaft on the tail rudder mounting bracket, enabling the first tail rudder blade to rotate around the first rotating shaft under a movement of the first steering gear push rod; wherein the second steering gear push rod connects the second steering gear with the second tail rudder component, and wherein the second tail rudder component is rotatably connected with a second rotating shaft on the tail rudder mounting bracket, enabling the second tail rudder blade to rotate around the second rotating shaft under a movement of the second steering gear push rod.

11. The flapping-wing aircraft according to claim 10, wherein the first steering gear push rod is connected with the first steering gear through a first steering gear rotating boom, wherein the second steering gear push rod is connected with the second steering gear through a second steering gear rotating boom, wherein when the first steering gear acts, it drives the first steering gear rotating boom to swing, thereby pulling the first steering gear push rod to move; and wherein when the second steering gear acts, it drives the second steering gear rotating boom to swing, thereby pulling the second steering gear push rod to move.

12. The flapping-wing aircraft according to claim 10, wherein the tail wing mechanism further comprises a steering gear mounting bracket on which the first steering gear and the second steering gear are mounted, and wherein a supporting rod is connected between the steering gear mounting bracket and the tail rudder mounting bracket.

13. The flapping-wing aircraft claim 1, comprising a controller, wherein the controller controls one of the first tail rudder blade and the second tail rudder blade to be uplifted, so that the flapping-wing aircraft turns towards a direction corresponding to the uplifted tail rudder blade; and/or, the controller controls both the first tail rudder blade and the second tail rudder blade to be uplifted, so that the flapping-wing aircraft climbs upwards.
